(19) United States
(12) Patent Application Publication
(10) Pub. No.: US 2019/0109938 A1
(43) Pub. Date: Apr. 11, 2019

(54) MESSAGE DISPLAY METHOD ACCORDING TO EVENT OCCURRENCE IN VR DEVICE AND APPARATUS THEREFOR

(71) Applicant: JOYFUN INC.,, Seoul (KR)

(72) Inventors: Sang Kwon JEONG, Seoul (KR); Gook Hwan LEE, Anyang-si (KR); Hyun Sam KANG, Seoul (KR)

(73) Assignee: JOYFUN INC.,, Seoul (KR)

(21) Appl. No.: 16/088,683

(22) PCT Filed: Apr. 17, 2017
(86) PCT No.: PCT/KR2017/004090

§ 371 Date: Sep. 26, 2018

(30) Foreign Application Priority Data
Apr. 29, 2016 (KR) 10-2016-0052791

(51) Int. Cl. H04M 1/725; G06F 3/01; G09G 3/00; G09G 5/377

(52) U.S. Cl. CPC H04M 1/72547; G06F 3/013; G09G 3/003; G06F 3/04845; G06F 3/012; H04M 1/72527; G09G 2354/00; G09G 5/377

(57) ABSTRACT

The present invention relates to: a message display method according to an event occurrence in a virtual reality (VR) device, wherein, when an event such as a telephone call, a text receipt such as an SMS, and a message receipt using a messenger program or an application occurs, during the displaying of a stereoscopic image through a head mounted display (HMD)-based VR device, in a communication terminal such as a smart phone combined with the VR device, a message according to an event occurrence is displayed by linking with a screen of the stereoscopic image being currently reproduced, thereby solving problems of severe discomfort sensation, which have occurred in conventional methods in which a message according to an event occurrence is displayed in a shape such as a black-based bar or box distinctly different from the stereoscopic image being currently reproduced, and thus is seen as an error message; and an apparatus therefor.

### TECHNICAL FIELD

The present invention relates to: a message display method according to an event occurrence in a virtual reality (VR) device, wherein when an event such as a telephone call, receipt of a text message such as a short message service (SMS), and receipt of a message by means of a messenger program or an application occurs during the displaying of a stereoscopic image through a head mounted display (HMD)-based VR device on a communication terminal such as a smart phone combined with the VR device, a message according to an event occurrence is linked with the screen of the stereoscopic image currently being reproduced and is displayed, thereby solving problems of severe discomfort sensation, which have occurred in conventional methods in which a message according to an event occurrence is displayed in a shape such as a black-based bar or box etc. distinctly different from the stereoscopic image being currently reproduced, and thus is seen as an error message; and an apparatus therefor.

### RELATED ART

In recent years, three-dimensional (3D) imaging technology using the difference in vision between both eyes has been widely used for flat panel hardware so as to allow users to watch stereoscopic images. Unlike two-dimensional (2D) images, 3D images provide information relating to depth and space and seem real. That is, a 3D image is the one that is combined in the process of recognizing an experienced environment with volume by both eyes and dealing with the information on the environment by the brain and that is related to the concept of space. Thus, users can feel like they are on the scene, and an object is virtually real.

3D imaging is a part of VR that is a computer-generated situation or environment so as to allow users to experience the situation and environment with their sensory organs, to pay attention and to interact. VR can be divided into augmented reality that layers virtual information over a real environment so as to give users the ability to view three-dimensional images, and mixed reality (MR) that is the merging of real and virtual worlds to produce new environments and is divided into augmented reality and augmented virtuality on the basis of a reality-based environment or a virtual reality-based environment.

Additionally, 3D imaging technology can be divided into a large system and a portable system.

The large system includes a projection module for outputting massive images, a screen module for displaying images, a left-eye and right-eye visual information separation module for binocular viewing, a projector attachment polarizing filter, stereoscopic glasses etc. so as to allow a large number of users in a space for virtual reality in a theme park or in a 3D theater to see stereoscopic images simultaneously.

The examples of the portable system are a HMD/face mounted display (PMD). Such displays include left-eye and right-eye modules for a stereoscopic visual display separately, and are configured to combine a micro display device and an optical magnifying structure like glasses and to receive information on images of two channels. They are used in the situation where personal information is visualized or where users feel free to move such as mobile computing.

In particular, the displays can be easily combined with a communication terminal such as a smart phone used by most people etc. Thus, it is highly likely that a HMD-based VR device is widely used and greatly affects and changes our daily lives.

Additionally, the VR industry based on HMD is an industry where various technologies and studies are integrated. Thus, it is expected to stimulate mutual growth of the upstream industry such as medicine, education, games etc. and the downstream industry such as a display, SW, communication etc.

For instance, 3D imaging technology is used to treat post-traumatic stress disorder (PTSD), various phobias (acrophobia, social phobia, claustrophobia), depression, is used to educate infants and children who undergo intellectual development and is used for specific training (personality/aptitude test, sport training, debate/presentation training etc.). Additionally, such 3D imaging technology can be used for surgery, industrial training, a military drill, piloting, a fire drill etc. to which virtual reality simulation is applied.

However, in the case of the above-described HMD-based VR device, a message according to an event occurrence is displayed in a shape such as a black-based bar or box etc. distinctly different from the stereoscopic image being currently reproduced, and is seen as an error message by users thereby causing an uncomfortable sensation to the users when an event such as a telephone call, receipt of a text message such as an SMS etc., and receipt of a message by means of a messenger program or an application etc. occurs on a communication terminal such as a smart phone etc. combined with the VR device in the process where the users confirm the stereoscopic image.

Thus, the present invention is directed to providing a method for solving the problem that users feel an uncomfortable sensation or that they see a message according to an event occurrence as an error message, by linking a message according to an event occurrence with the screen of the stereoscopic image currently being reproduced so as to display the message according to an event occurrence when an event such as a telephone call, receipt of a text message such as an SMS etc., and receipt of a message by means of a messenger program or an application etc. occurs on a communication terminal such as a smart phone etc. combined with a VR device while the HMD-based VR device is being used. That is, as a means to solve conventional problems, the present invention is directed to providing a message display method according to an event occurrence like a caption by linking the message according to an event occurrence with a stereoscopic image.

Related arts of the present invention will be briefly described, and technical features of the present invention different from those of the related arts will be described.

First, South Korean Patent Laid-Open publication No. 10-200-0117431 (Dec. 12, 2007) relates to a stereoscopic image reproducing system and more specifically, to a stereoscopic image reproducing system capable of applying various types of virtual reality software and reproducing stereoscopic images of different formats so as to make a stereoscopic image reproducing system widely available and to reduce the cost of manufacturing a stereoscopic image reproducing system.

The above-described art is to reproduce stereoscopic images of different formats. Unlike the related art, the present invention links a message according to an event occurrence such as a telephone call, receipt of a text message etc. with a stereoscopic image being currently reproduced so as to display the message according to an event occurrence while the stereoscopic image is being reproduced. Therefore, the present invention differs from the related art.

Further, South Korean Patent No. 10-0809479 (Feb. 26, 2008) relates to a face mounted display apparatus in a mixed reality environment and more specifically to a face mounted display apparatus and method for a mixed reality environment.

The related art is capable of naturally merging information on an image from the outside of an FMD apparatus and information on a personal image in a mixed reality environment where various artificial images are mixed with external natural images, so as to solve the problem of an unnatural depth generated in a mixed reality environment using individually suggested stereoscopic image technologies, or an unnatural interaction between actual images and virtual objects etc.

Unlike the related art that solves unnatural phenomena in images in a mixed reality environment, the present invention links a message according to an event occurrence such as a telephone call, receipt of a text message etc. with a stereoscopic image being currently reproduced so as to display the message according to an event occurrence while the stereoscopic image is being reproduced. Therefore, the present invention differs from the related art.

### DETAILED DESCRIPTION OF THE INVENTION

### Technical Problems

As a means to solve the above-described problems, the present invention is directed to providing a message display method according to an event occurrence in a VR device, wherein a message according to an event occurrence is linked with the screen of the stereoscopic image currently being reproduced such that the message according to an event occurrence such as a telephone call, receipt of a text message such as an SMS etc., and receipt of a message by means of a messenger program or an application etc. is displayed on a communication terminal such as a smart phone etc. combined with a VR device, and an apparatus therefor.

Additionally, the present invention is directed to providing a message display method according to an event occurrence in a VR device, wherein users can freely change the position and size of a message according to an event occurrence when the message according to an event occurrence is linked with the screen of the stereoscopic image currently being reproduced so as to be displayed, and an apparatus therefor.

Further, the present invention is directed to providing a message display method according to an event occurrence in a VR device, wherein a function of stopping displaying a message according to an event occurrence by the user using a VR device for a certain period of time is further included such that the user pays attention to stereoscopic images, and an apparatus therefor.

### Technical Solutions

A message display method according to an event occurrence in a VR device according to an embodiment of the present invention may include an event message confirming step of confirming a message according to an event occurrence displayed on the screen of the communication terminal; and an event message processing step of linking the message according to an event occurrence respectively with left-eye and right-eye stereoscopic images and outputting the message according to an event occurrence together with the left-eye and right-eye stereoscopic images in the process of outputting image signals reproduced on a communication terminal as left-eye and right-eye stereoscopic images through a VR device.

Additionally, the left-eye and right-eye stereoscopic images may be generated from image signals reproduced on the communication terminal with reference to a user's visual information including positions, directions, focuses of the user's eyes according to rotation in upward, downward, left and right directions on the basis of sense signals input by one or more of a position sensor, a gyro sensor, an acceleration sensor or a combination thereof provided to the VR device.

Additionally, the message according to an event occurrence confirmed in the event message confirming step can be a telephone call from the outside, receipt of a text message including an SMS, receipt of a message by means of a messenger program or an application, or one or more of a combination thereof.

Additionally, the event message processing step can include linking the message according to an event occurrence of the communication terminal respectively with the left-eye and right-eye stereoscopic images so as to display the message according to an event occurrence in the state where the position and size of the message according to an event occurrence are adjusted on the basis of the user's input.

Additionally, the event message processing step may include deleting the message according to an event occurrence confirmed in the event message confirming step on the basis of the user's input so as to stop displaying the message according to an event occurrence.

Further, a message display apparatus according to an event occurrence in a VR device according to an embodiment of the present invention includes an event message confirming unit for confirming a message according to an event occurrence displayed on the screen of a communication terminal; and an event message processing unit for linking the message according to an event occurrence confirmed by the event message confirming unit respectively with left-eye and right-eye stereoscopic images and outputting the message according to an event occurrence together with the left-eye and right-eye stereoscopic images, in the process of outputting image signals reproduced on a communication terminal as left-eye and right-eye stereoscopic images through a VR device.

Additionally, the VR device can further include an input manipulating unit for generating key signals for setting a function or a configuration of the VR device according to a user's manipulation.

Additionally, the communication terminal is preferably fixed to the front of the VR device.

Additionally, the left-eye and right-eye stereoscopic images can be generated from image signals reproduced on the communication terminal with reference to a user's visual information including positions, directions, focuses of the user's eyes according to rotation in upward, downward, left and right directions on the basis of sense signals input by one or more of a position sensor, a gyro sensor, an acceleration sensor or a combination thereof provided to the VR device.

Additionally, the message according to an event occurrence can be a telephone call from the outside, receipt of a text message including an SMS, receipt of a message by means of a messenger program or an application, or one or more of a combination thereof.

Additionally, the event message processing unit can display the message according to an event occurrence of the communication terminal in 3D space by overlaying the message according to an event occurrence respectively with the left-eye and right-eye stereoscopic images on the basis of the user's input through the input manipulating unit in the state where the position and size of the message according to an event occurrence are adjusted.

Additionally, the event message processing unit can delete the message according to an event occurrence confirmed by the message confirming unit on the basis of the user's input through the input manipulating unit so as to stop displaying the message according to an event occurrence in 3D space.

### Advantageous Effects

As described above, according to a message display method according to an event occurrence in a VR device and an apparatus therefor according to the present invention, a message according to an event occurrence such as a telephone call, receipt of a text message including an SMS, receipt of a message by means of a messenger program or an application etc. generated by a communication terminal such as a smart phone etc. coupled to a VR device can be linked with the screen of the stereoscopic image currently being reproduced so as to be displayed when stereoscopic images are displayed through devices. Thus, a message according to an event occurrence can be displayed together with stereoscopic images that are being currently reproduced. As a result, the problem that a message displayed in the shape of a black-based bar or box etc. is seen as an error message can be solved.

Further, users using a VR device can adjust the position and size of a message according to an event occurrence to their taste so as to display the message according to an event occurrence. Thus, a product can function in various ways and the quality of a product can be improved.

Further, a function of stopping displaying a message according to an event occurrence by the user using a VR device for a certain period of time is further included such that the user pays attention to stereoscopic images without being interfered by an external factor.

### BRIEF DESCRIPTION OF THE DRAWINGS

FIG. 1 is a view schematically illustrating a configuration of a message display apparatus according to an event occurrence in a VR device according to an embodiment of the present invention.

FIG. 2 is a conceptual view specifically illustrating a process of displaying a message according to an event occurrence in a VR device, to which the present invention is applied.

FIG. 3 is a view specifically illustrating a configuration of a VR device, to which a function of displaying a message according to an event occurrence is applied according to an embodiment of the present invention.

FIG. 4 is a flow chart specifically illustrating operations in a process of displaying a message according to an event occurrence in a VR device according to an embodiment of the present invention.

### MODE FOR CARRYING OUT THE INVENTION

A message display method according to an event occurrence in a VR device, and an apparatus therefor, according to the present invention, will be described in detail with reference to the attached drawings. The present invention can be modified in various different forms and is not construed as being limited to the embodiments set forth herein.

Throughout the specification, like reference numerals denote like elements.

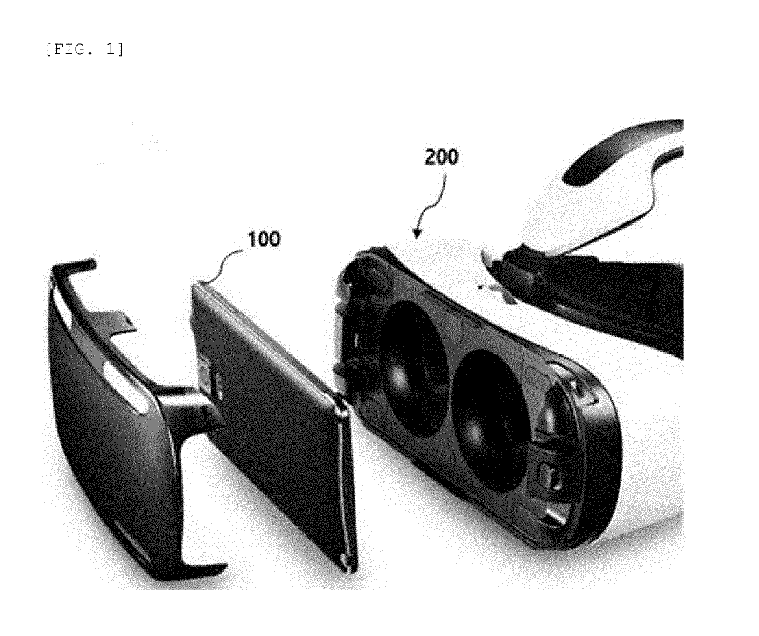

FIG. 1 is a view schematically illustrating a configuration of a message display apparatus according to an event occurrence in a VR device according to an embodiment of the present invention.

A VR device 200 used for the present invention, as illustrated, is a goggle-type head-mounted display (HMD)-based device, and a communication terminal 100 such as a smart phone etc. for providing stereoscopic images is fixed between a front cover and a body.

Additionally, the VR device 200 generates and outputs a stereoscopic image signal of an image generated by the communication terminal 100 fixed to the front of a body on the basis of a user's visual information such as positions, directions, focuses of eyes etc.

Accordingly, a user wearing a goggle-type VR device can see the stereoscopic image while freely changing positions up, down, backwards and forwards.

In the process of outputting such a stereoscopic image, an event such as a telephone call from the outside, receipt of a text message such as an SMS etc. receipt of a message by a messenger program or an application etc. can occur to the communication terminal 100. In this case, the VR device links a message according to an event occurrence with the screen of the stereoscopic image currently being reproduced and displays the message. That is, a message according to an event occurrence is naturally overlaid with the screen of the stereoscopic image currently being reproduced so as to be displayed not in the way in which a message according to an event occurrence is displayed in the shape of a black-base bar or box etc.

In this case, the present invention is described considering that the communication terminal is configured as a HMD-based VR device that is fixed to the front, but the communication terminal is not limited to a HMD-based VR device. The VR device itself can be provided with a means for communication receiving images, a display means to play received images etc. so as to receive images from the communication terminal and to output stereoscopic images through a cable or wireless internet etc.

Further, the present invention can be certainly applied to all sorts of electronic devices to which well-known 3D stereoscopic technologies such as polarizing, shuttering and anaglyph where glasses are used, lenticular lenses and a parallax barrier where glasses are not used etc. are applied, in addition to a HMD-based VR device.

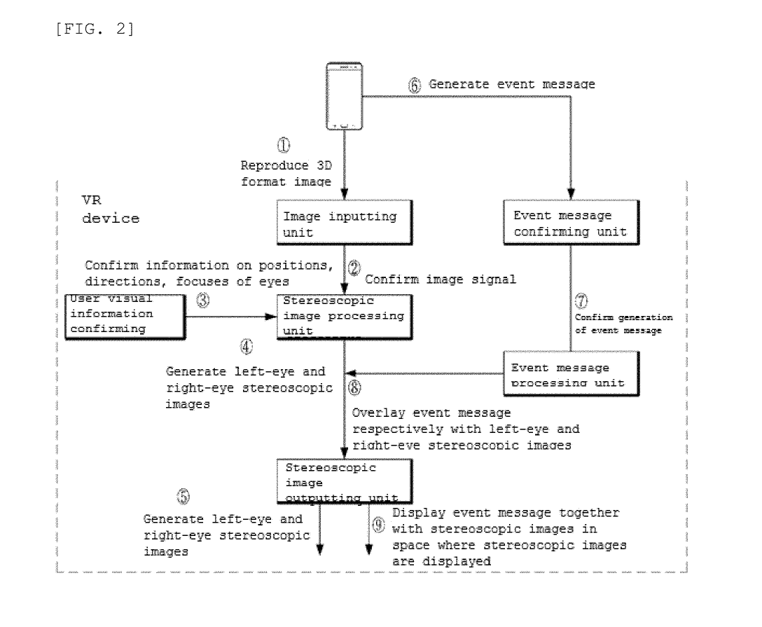

FIG. 2 is a conceptual view specifically illustrating a process of displaying a message according to an event occurrence in a VR device to which the present invention is applied.

As illustrated in FIG. 2, a user fixes a communication terminal such as a smart phone etc. to the front of the body of a HMD-based VR device. In this state, the user wears the VR device on the head like the user wears a goggle on the head, and manipulates the driving of the communication terminal so as to play 3D images (\textcircled{1}).

Then, the VR device confirms image signals reproduced on the communication terminal (\textcircled{2}), and confirms various sorts of the user's visual information such current positions, current directions, current focuses etc. of the user's eyes on the basis of data sensed through various sensors such as a position sensor, a gyro sensor, an acceleration sensor etc. that are provided at a certain position of the VR device (\textcircled{3}).

Then the VR device generates left-eye and right-eye stereoscopic images from the image reproduced on the communication terminal on the basis of the visual information such as positions, directions, focuses etc. of the user's eyes (\textcircled{4}), and outputs the generated left-eye and right-eye stereoscopic images such that the user can confirm the left-eye and right-eye images (\textcircled{5}). That is, the user can see a stereoscopic image giving an illusion of depth and looking real according to a movement of the user's head on which the goggle-type VR device is worn, and a direction of the user's eyes.

As described, in the process of outputting stereoscopic images, the VR device confirms whether a preset event message is displayed on the screen according to the occurrence of a specific event such as a telephone call from the outside, receipt of a text message including an SMS etc., receipt of a message by means of a messenger program or an application etc. (\textcircled{6}), and confirms what sort of event message occurs when an event message is displayed on the communication terminal (\textcircled{7}). That is, the VR device confirms whether an event message occurs by using a method of capturing an event message displayed on the screen of a communication terminal etc. so as to prepare for displaying an event message.

The VR device having confirmed the generation of an event message overlays the event message respectively with the left-eye and right-eye stereoscopic image signals being currently reproduced (\textcircled{8}), and displays the overlaid message according to an event occurrence together with the stereoscopic images in a space where stereoscopic images are displayed so as to allow the user to easily confirm what sort of event occurs (\textcircled{9}). That is, the message according to an event occurrence is displayed so as to be mixed well with the stereoscopic images being currently reproduced. Thus, the user does not see the message according to an event occurrence as an error message and does not feel an uncomfortable sensation.

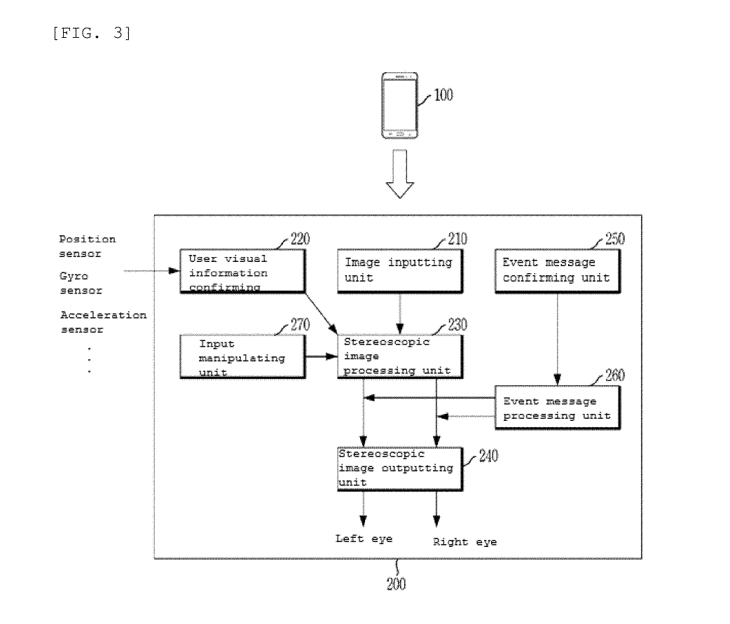

FIG. 3 is a view specifically illustrating a configuration of a VR device 200 to which a function of displaying a message according to an event occurrence is applied according to an embodiment of the present invention.

A VR device 200, as illustrated, includes an image inputting unit 210, a user visual information confirming unit 220, a stereoscopic image processing unit 230, a stereoscopic image outputting unit 240, an event message confirming unit 250, an event message processing unit 260, an input manipulating unit 270 etc. Certainly, the VR device can further include a power unit (invisible), a control unit (invisible) etc.

The image inputting unit 210 receives 3D image signals reproduced on the communication terminal 100 and outputs image signals reproduced on the communication terminal 100 to the stereoscopic image processing unit 230.

The user visual information confirming unit 220 confirms information such as positions, directions, focuses of a user's eyes according to rotation in upward, downward, left and right directions on the basis of signals sensed by sensors provided to the VR device 200, and outputs a user's visual information including positions, directions, focuses etc. of the user's eyes to the stereoscopic image processing unit 230. That is, the user visual information confirming unit 220 confirms information such as positions, directions, focuses of a user's eyes according to rotation in upward, downward, left and right directions on the basis of sense signals input by one or more of a position sensor, a gyro sensor, an acceleration sensor or a combination thereof provided to a certain position of the VR device 200, and supplies the visual information to the stereoscopic image processing unit 230.

The stereoscopic image processing unit 230 generates left-eye and right-eye stereoscopic images from image signals input by the image inputting unit 210 wither reference to information such as positions, directions, focuses of a user's eyes, which is confirmed by the user visual information confirming unit 220.

That is, the stereoscopic image processing unit 230 processes the depth, perspective, height etc. in image signals input by the image inputting unit 210 so as to generate a stereoscopic image on the basis of a user's visual information, thereby allowing the user to see a stereoscopic image giving an illusion of depth and looking real.

The stereoscopic image outputting unit 240 outputs the left-eye and right-eye stereoscopic images generated by the stereoscopic image processing unit 230 in 3D space such that the user can confirms the output stereoscopic image.

The event message confirming unit 250 confirms a message according to an event occurrence displayed on the screen of the communication terminal 100 and provides the message to the event message processing unit 260.

In this case, a message according to an event occurrence can be a telephone call from the outside, receipt of a text message including an SMS, receipt of a message by means of a messenger program or an application, or one or more of a combination thereof.

For instance, when an event message is displayed on the screen of the communication terminal 100, the event message confirming unit 250 generally captures the event message displayed on a specific section of the screen and then outputs the captured image to the event message processing unit 260. In this case, the way in which the event message confirming unit 250 confirms a message according to an event occurrence is not limited to the above-described way in which the event message confirming unit 250 captures the event message displayed on a specific section of the screen. Certainly, all the well-known methods such as a method of recognizing a message displayed section in an image that is being reproduced through a software process etc. can be used to confirm a message according to an event occurrence.

The event message processing unit 260 overlays a message according to an event occurrence confirmed by the event message confirming unit 250 respectively with left-eye and right-eye stereoscopic images generated by the stereoscopic image processing unit 230 and outputs the event message in 3D space where a stereoscopic image is output through the stereoscopic image outputting unit 240.

In this case, the event message processing unit 260 can overlay the message according to an event occurrence of the communication terminal 100 respectively with left-eye and right-eye stereoscopic images and displays the message according to an event occurrence in 3D space, in the state where the position and size of the message according to an event occurrence are adjusted on the basis of the user's input.

Additionally, the event message processing unit 260 can delete a message according to an event occurrence confirmed by the event message confirming unit 250 on the basis of the user's setting so as not to display the event message in 3D space.

That is, if an event message is produced while a VR device 200 is being used, the event message processing unit may not display the event message such that the user pays attention to stereoscopic images.

The input manipulating unit 270 generates various functions embodied in a VR device 200 or key signals for a configuration according to the user's manipulation, and outputs the generated key signals to the stereoscopic image processing unit 230.

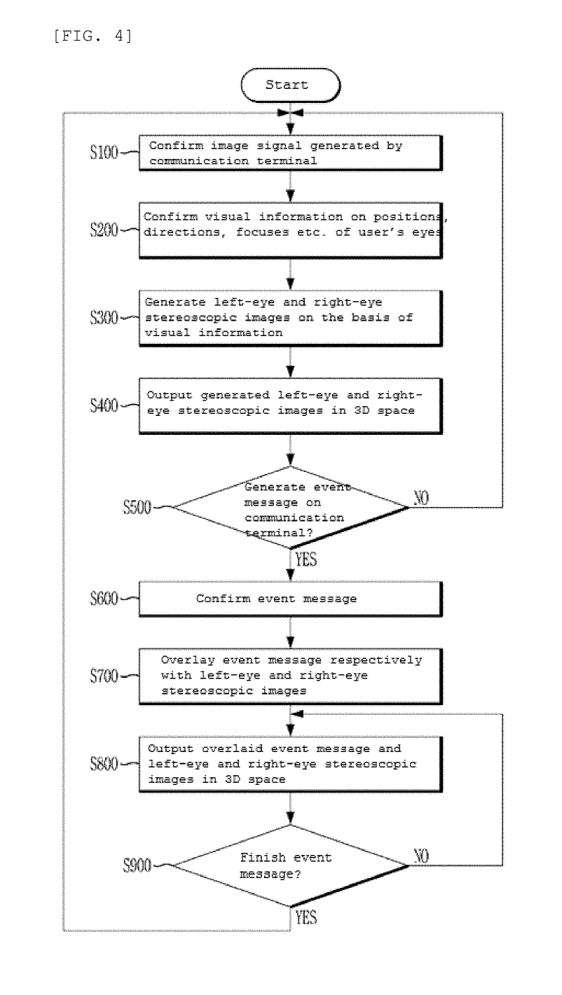

An embodiment of a message display method according to an event occurrence in a VR device according to the present invention with the above-described configuration will be described in detail with reference to FIG. 4. In this case, the order of the steps according to a method of the present invention can be changed depending on the conditions for use or by those in the art to which the present invention pertains.

FIG. 4 is a flow chart specifically illustrating operations in a process of displaying a message according to an event occurrence in a VR device according to an embodiment of the present invention.

First, a user wears a HMD-based VR device 200 to which a communication terminal 100 is fixed on the head like the user wears a goggle on the head and drives the communication terminal 100 so as to generate 3D images. Then, the VR device 200 confirms image signals reproduced on the communication terminal 100 fixed to the front of the VR device (S100).

The VR device 200 confirms a 3D image reproduced on the communication terminal 100 and at the same time, confirms visual information such as positions, directions, focuses etc. of the user's eyes according to rotation in upward, downward, left and right directions on the basis of sense signals sensed by sensors (S200). That is, the VR device 200 confirms visual information such as current positions, current directions, current focuses etc. of the user's eyes on the basis of data sensed by various sensors such as a position sensor, a gyro sensor, an acceleration sensor etc.

Then the VR device 200 generates left-eye and right-eye stereoscopic images from image signals confirmed in step 100 with reference to information such as positions, directions, focuses of a user's eyes, which is confirmed in step 200 (S300), and outputs the generated left-eye and right-eye stereoscopic images in 3D space (S400). That is, the user can see a stereoscopic image giving an illusion of depth and looking real according to a movement of the user's head on which the goggle-type VR device is worn, and a direction of the user's eyes. In this case, the outputting of the stereoscopic images in step 400 is continuously performed until the reproducing of images on the communication terminal 100 finishes or the user stops reproducing images.

Now, the VR device 200 determines whether the event message is displayed according to the occurrence of a specific event such as a telephone call from the outside, receipt of a text message such as an SMS etc., receipt of a message by means of a messenger program or an application etc. on the screen of the communication terminal in the process where the stereoscopic images are watched through S400 (S500).

When the message according to an event occurrence is displayed on the screen of the communication terminal 100 as a result of the determination in S500, the VR device confirms the message according to an event occurrence on the screen of the communication terminal 100 (S600). That is, the VR device 200 confirms the generation of the event message in the way that captures the event message on the screen of the communication terminal 100 etc.

After confirming the message according to an event occurrence in S600, the VR device 200 overlays the message according to an event occurrence respectively with the left-eye and right-eye stereoscopic images having generated in S300 (S700) and outputs the overlaid message according to an event occurrence together with the stereoscopic images in 3D space (S800). That is, the message according to an event occurrence is displayed so as to be mixed well with the stereoscopic images being currently reproduced. Thus, the user does not see the message according to an event occurrence as an error message and does not feel an uncomfortable sensation.

The message according to an event occurrence output together with the stereoscopic images is displayed until the event message on the screen of the communication terminal 100 finishes being displayed (S900).

In this case, the message according to an event occurrence displayed together with the stereoscopic images in S800 can be displayed in the state where the position and size of the message according to an event occurrence are adjusted on the basis of the setting of the user.

Additionally, the displaying of the message according to an event occurrence that is displayed together with the stereoscopic images in S800 can be stopped on the basis of the setting of the user such that the user pays attention to the stereoscopic images.

As described above, the present invention can naturally display a message according to an event occurrence together with stereoscopic images currently being reproduced, by solving the conventional problem that a message according to an event occurrence is displayed in the shape of a black-based bar or box etc. and is seen as an error message causing an uncomfortable sensation to a user.

Further, the present invention can display a message according to an event occurrence by adjusting the position and size of the message according to an event occurrence to the taste of a user using the VR device, and when the function of stopping displaying a message according to an event occurrence for a certain period of time is used by the user, the user can pay attention only to stereoscopic images without being interfered with by an external factor.

Herein, the present invention has been described with reference to the preferred embodiments. However, it will become apparent to one skilled in the art to which the present invention pertains that the present invention can be variously modified and changed without departing from the spirit and scope of the present invention described in the appended claims.

### DESCRIPTION OF THE SYMBOLS

100: Communication terminal 200: VR device

210: Image inputting unit 220: User visual information confirming unit

230: Stereoscopic image processing unit 240: Stereoscopic image outputting unit

250: Event message confirming unit 260: Event message processing unit

270: Input manipulating unit

1. A message display method according to an event occurrence in a virtual reality (VR) device comprising:
an event message confirming step of confirming a message according to an event occurrence displayed on a screen of a communication terminal; and
an event message processing step of linking the message according to an event occurrence respectively with left-eye and right-eye stereoscopic images and outputting the message according to an event occurrence together with the left-eye and right-eye stereoscopic images in a process of outputting image signals reproduced on the communication terminal as the left-eye and right-eye stereoscopic images through a VR device.

2. The message display method according to claim 1,
wherein the left-eye and right-eye stereoscopic images are generated from image signals reproduced on the communication terminal with reference to a user's visual information including positions, directions, focuses of the user's eyes according to rotation in upward, downward, left and right directions on the basis of sense signals input by one or more of a position sensor, a gyro sensor, an acceleration sensor or a combination thereof provided to the VR device.

3. The message display method according to claim 1,
wherein the message according to an event occurrence confirmed in the event message confirming step is a telephone call from the outside, receipt of a text message including a short message service (SMS), receipt of a message by means of a messenger program or an application, or one or more of a combination thereof.

4. The message display method according to claim 1,
wherein the event message processing step comprises linking the message according to an event occurrence of the communication terminal respectively with left-eye and right-eye stereoscopic images so as to display the message according to an event occurrence in the state where a position and size of the message according to an event occurrence are adjusted on the basis of a user's input.

5. The message display method according to claim 1,
wherein the event message processing step comprises deleting the message according to an event occurrence confirmed in the event message confirming step on the basis of a user's input so as to stop displaying the message according to an event occurrence.

6. A message display apparatus according to an event occurrence in a VR device comprising:
an event message confirming unit for confirming a message according to an event occurrence displayed on a screen of a communication terminal; and
an event message processing unit for linking the message according to an event occurrence confirmed by the event message confirming unit respectively with left-eye and right-eye stereoscopic images and outputting the message according to an event occurrence together with the left-eye and right-eye stereoscopic images in a process of outputting image signals reproduced on the communication terminal as the left-eye and right-eye stereoscopic images through a VR device.

7. The message display apparatus according to claim 6,
wherein the message display apparatus further comprises an input manipulating unit for generating key signals for setting a function or a configuration of the VR device according to a user's manipulation.

8. The message display apparatus according to claim 6, wherein the communication terminal is fixed to the front of the VR device.

9. The message display apparatus according to claim 6, wherein the left-eye and right-eye stereoscopic images are generated from image signals reproduced on the communication terminal with reference to a user's visual information including positions, directions, focuses of the user's eyes according to rotation in upward, downward, left and right directions on the basis of sense signals input by one or more of a position sensor, a gyro sensor, an acceleration sensor or a combination thereof provided to the VR device.

10. The message display apparatus according to claim 6,
wherein the message according to an event occurrence is a telephone call from the outside, receipt of a text message including an SMS, receipt of a message by means of a messenger program or an application, or one or more of a combination thereof.

11. The message display apparatus according to claim 7,
wherein the event message processing unit links the message according to an event occurrence of the communication terminal respectively with left-eye and right-eye stereoscopic images and displays the message according to an event occurrence in the state where a position and size of the message according to an event occurrence are adjusted through the input manipulating unit on the basis of the user's input

12. The message display apparatus according to claim 7,
wherein the event message processing unit deletes the message according to an event occurrence confirmed by the event message confirming unit on the basis of the user's input through the input manipulating unit so as to stop displaying the message according to an event occurrence.
